(19) United States
(12) Patent Application Publication
(10) Pub. No.: US 2021/0014655 A1
(43) Pub. Date: Jan. 14, 2021

(54) System and Method for Supporting Two Versions of V2X Standard

(71) Applicant: Continental Automotive Systems, Inc., Auburn Hills, MI (US)

(72) Inventor: Ulrich Stählin, Oakland Township, MI (US)

(73) Assignee: Continental Automotive Systems, Inc., Auburn Hills, MI (US)

(21) Appl. No.: 16/923,330

(22) Filed: Jul. 8, 2020

Related U.S. Application Data
(60) Provisional application No. 62/872,937, filed on Jul. 11, 2019.

(51) Int. Cl. H04W 4/40

(52) U.S. Cl. CPC H04W 4/40

(57) ABSTRACT

A method for supporting at least two versions of a vehicle-to-everything (V2X) standard is provided. The method includes receiving, at data processing hardware, an incoming message from a communication system. The method also includes determining, at the data processing hardware, a version of the V2X standard associated with the incoming message. When the version of the V2X standard associated with the incoming message is an old version, the method includes transmitting, from the data processing hardware, a first outgoing message supporting a current version of the V2X standard; and transmitting, from the data processing hardware, a second outgoing message supporting the old version of the V2X standard.

### CROSS-REFERENCE TO RELATED APPLICATIONS

This U.S. patent application claims priority under 35 U.S.C. § 119(e) to U.S. Provisional Application 62/872,937, filed Jul. 11, 2019, which is hereby incorporated by reference in its entirety.

### TECHNICAL FIELD

This disclosure relates to a system and method for supporting two versions of Vehicle-to-everything (V2X) standard in a bandwidth efficient manner.

### BACKGROUND

Vehicle-to-everything (V2X) communication is the process of transmitting information from a vehicle to any entity that may affect the vehicle, and vice versa. V2X includes several types of communication, such as, but not limited to V2I (vehicle-to-infrastructure), V2N (vehicle-to-network), V2V (vehicle-to-vehicle), V2P (vehicle-to-pedestrian), V2D (vehicle-to-device), and V2G (vehicle-to-grid). V2X allows communication between the vehicle and other entities which results in road safety, traffic efficiency, and energy savings.

Currently on the market, some vehicles are using an older version of the V2X standard. With the newer versions of the V2X standard, the physical layer has stayed the same, however, message formats, etc. have been adjusted. In order to support those older vehicles having the older version of the V2X standard, a new vehicle has to incorporate two versions of the standards: the old version and the current version. Since both standards would require sending different messages, this would have a negative impact on the consumed bandwidth with very little benefit, since only very few of the old vehicles exist. Therefore, it is desirable to have a system that is configured to support both version of the V2X standard, the new version and the old version.

### SUMMARY

One aspect of the disclosure provides a method for supporting at least two versions of a vehicle-to-everything (V2X) standard. The method includes receiving, at data processing hardware, an incoming message from a communication system. The method also includes determining, at the data processing hardware, a version of the V2X standard associated with the incoming message. When the version of the V2X standard associated with the incoming message is an old version, the method includes transmitting, from the data processing hardware, a first outgoing message supporting a current version of the V2X standard; and transmitting, from the data processing hardware, a second outgoing message supporting the old version of the V2X standard.

Implementations of the disclosure may include one or more of the following optional features. In some implementations, when the version of the V2X standard associated with the incoming message is the current version: the method includes transmitting, from the data processing hardware, the first outgoing message supporting the current version of the V2X standard.

In some examples, the data processing hardware executes one or more applications configured to receive the incoming message and output the first outgoing message and the second outgoing message. The one or more applications may include at least one of: Intersection Movement Assist (IMA), Forward Collision Warning (FCW), and Do Not Pass Warning (DNPW), Left Turn Assist (LTA), Electronic Emergency Brake Light (EEBL), Signal Violation Warning (SVW), Traffic Light Assist (TLA), or Green Light Optimized Speed Advisory (GLOSA). The one or more applications may include any other application configured to receive the incoming message and output the first outgoing message and the second outgoing message.

Another aspect of the disclosure provides a system that includes data processing hardware and memory hardware in communication with the data processing hardware. The memory hardware stores instructions that when executed on the data processing hardware cause the data processing hardware to perform operations to perform operations. These operations include the method described above.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary overview of a vehicle having a pre-filtering module.

FIG. 2 is a schematic view of an exemplary arrangement of operations for a method of supporting at least two versions of a vehicle-to-everything (V2X) standard.

Like reference symbols in the various drawings indicate like elements.

### DETAILED DESCRIPTION

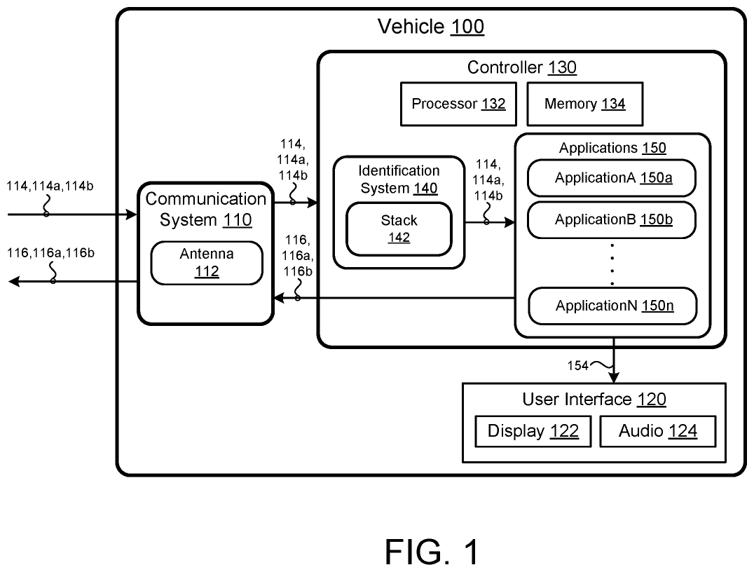

Referring to FIG. 1, in some implementations, a vehicle 100 is equipped with a communication system 110 that allows the vehicle 100 to communicate with other entities such as other vehicles, an infrastructure, a network, a pedestrian, a device, and/or a grid. The communication system 110 may include a V2X communication system. The V2X communication system may use one or more of the following connection classes to send and/or receive messages and/or information: WLAN connection, e.g., based on IEEE 802.11, ISM (Industrial, Scientific, Medical Band) connection, Bluetooth® connection, ZigBee connection, UWB (ultrawide band) connection, WiMax® (Worldwide Interoperability for Microwave Access) connection, LTE-V2X, Cellular V2X (C-V2X), Cellular Communication (3G, 4G, 5G, . . . ), Dedicated Short Range Communications (DSRC), infrared connection, mobile radio connection, and/or radar-based communication.

In some examples, the communication system 110 includes an antenna 112 for receiving messages/signals 114 and transmitting messages/signals 116, data processing hardware, and memory hardware capable of storing instructions that cause the data processing hardware to perform one or more operations.

The vehicle 100 may include a user interface 120. In some examples, the user interface 120 includes a display 122 that provides the driver with a displayed message 154. The display 122 may be a touch screen display 122. The user interface 120 may include a rotary knob or a mouse to make a selection by the driver via the display 122. The user interface 120 may display one or more messages 154 to the driver. In some examples, the user interface 120 receives one or more user commands from the driver via one or more input mechanisms or the touch screen display 122 and/or displays one or more notifications to the driver, the driver input is for example, an acknowledgement of the received message 154. In some examples, the user interface 120 includes an audio system 124 that outputs an audible warning message 154. Other examples for user interfaces 120 include haptic seats, lights, Head-Up Displays or lightbars.

In some implementations, the vehicle 100 includes a controller 130. The vehicle controller 130 includes a computing device (or processor) 132 (e.g., central processing unit having one or more computing processors) in communication with non-transitory memory 134 (e.g., a hard disk, flash memory, random-access memory) capable of storing instructions executable on the computing processor(s) 132. The communication system 110 may be part of the controller 130, while in other examples, the communication system 110 is separate from the controller 130. The controller 130 executes an identification system 140 and one or more applications 150, 150a-150n. The identification system 140 includes a stack 142. The identification system 140 may also be part of the communication system 110.

The communication system 110 receives messages 114 and sends the received messages 114 to the identification system 140. The received messages 114 may be based on a current version of a communication standard or an older version of the communication standard. For example, a received message 114 may be based on an old version of the V2X standard, i.e., old format message 114a, or the received message 114 may be based on a current version of the V2X standard, i.e., current format message 114b. Therefore, the identification system 140, i.e., the stack 142, identifies the version of the V2X standard that the received message 114 is supported by and based on the identified version of the V2X standard of the received message 114 the controller 130 determines which version of the V2X standard should be used to output a message 116, 116a, 116b via the communication system 110.

The stack 142 identifies a version of the V2X standard of the received message 114, 114a, 114b. In addition, the stack 142 identifies one or more applications 150a-n that rely on the received one or more messages 114 to output a message 154 to the driver and/or to output one or more messages 116 via the communication system 110. In some examples, an optimized way of handling incoming messages 114 is implemented using a pre-check of a message header of each received message 114 and using synergies in the stack processing. For example, when using two or more versions of the stack 142 where the stacks have commonalities, then only one version pre-checks the message header of the received message 114.

In some examples, the controller 130 is configured to output messages 116 supporting the current version of the V2X standard, but when an old format message 114a is received that is based on an older version of the V2X standard, then the controller 130 outputs two versions or formats of the same message 116, a first old format message 116a formatted according to the old version of the V2X standard and a second current format message 116b formatted according to the current version of the V2X standard.

In some examples, one or more applications 150a-n receive the messages 114 from the stack 142. Each application 150a-n is configured to provide a different message 154 to the driver and/or a different message 116 via the communication system 110. Based on the version of the V2X standard associated with the received message 114 (old format message 114a or current format message 114b) the output message 116 of the one or more applications 150a-n changes. For example, if the received message 114a is old format message 114a, then the one or more applications 150a-n output two versions of the output messages 116, 116a, 116b (first old format message 116a which supports the same version of the V2X standard that the received old-format message 114a supports and second new format message 116b supporting the current version of the V2X standard. Additionally, if the received message 114b is in the current version of the V2X standard, then the one or more applications 150a-n output message 116a, 116b only in the current version of the V2X.

In some implementations, the controller 130 supports two or more versions of the V2X standard, i.e., the current version and one or more older versions. Therefore, the controller 130 is configured to output current format messages 116b based on the current version of the V2X standard. However, as soon and as long as messages 114, 114a, 114b are received that are based on an older version of the V2X standard, then the one or more applications 150, 150a-n additionally output at least two versions of the message, a first older format message messages 116a using the respective version of the standard that fits to the version used by the received messages (i.e., the older version of the standard) and a second current format message 116b. In some examples, the controller 130 may also output messages in other older versions of the V2X standard. Therefore, outgoing messages 116 are sent at least twice when the received message 114 is an old format message 114a, once for the new version of the standard (message 116b) and once using the old version of the standard (message 116a).

In some implementations, the communication system 110 sends the messages 116a, 116b supporting the old and current versions of the V2X standard in different ways.

For example, the communication system 110 sends both messages 116a, 116b supporting the old and current version of the V2X standard directly one after the other to reduce bandwidth loss even further by eliminating ideal times on the channel (those are coming from CSMA in case of 802.11p where the sender has to listen first if the channel is free). Normally, after sending each message 116, the sender waits and listens to the channel to determine if another system is sending any messages. The time for listening is defines as a minimum length by the communication standard (i.e., 802.11p). Therefore, when the communication system 110 sends both messages 116a, 116b supporting the old and current version of the V2X standard directly one after the other without listening to the channel in between sending the two messages 116a, 116b, then the short listening period is not lost for data throughout. In another example, the communication system 110 sends the messages 116a, 116b alternating (e.g., equally spaced) such that the communication system 110 does not block the outputting channel of the communication system 110 for too long. Both version of the messages 116a, 116b are sent with the full repetition rate required by the V2X standard.

In some examples, output messages 116a, 116b supporting the old and the current standard each fulfill the requirements and rules of their respective standards. As such, the content of each message 116a, 116b is formatted differently. In some examples, each version of the message 116a, 116b relies on different incoming messages 114 to generate the output message 116a, 116b. For example, if message forwarding is used the forwarding message is using the respective meta-data (i.e. hopping counts, hopping range, hopping time validity, . . . ) of the received message to put together the correct forwarding message

V2X standards define PKI (Public Key Infrastructure) which is a key element of the security and privacy of Intelligent Transport System (ITS) operating V2X communications. All ITS-units, including vehicles, infrastructure, network, pedestrian device, grids, and roadside units, which are equipped with a V2X communication system are registered with the V2X PKI. V2X communications provides specific restrictions, such as limited bandwidth, intermitted internet access, and privacy issues. As such, both the PKI and the format of the used certificates feature specific characteristics, since they are customized to fulfill requirements resulting from those restrictions. CA (Certificate Authority) and a certification of OBUs (On-Board Unit) ensure the trust between the communication system 110 of a current vehicle 100 and a unit transmitting a message received by the current vehicle 100. Therefore, since the controller 130 supports two versions of the V2X standard, then in some examples, different types of certificates are supported, and different PKI structures including different Root CAs may also be used for each outputted message 116, 116a, 116b supporting the different version of the V2X standard.

In some implementations, the controller 130 includes a misbehavior detection system (not shown) that detects messages containing incorrect data. In some examples of the prior art, when a system supporting a current version of the standard receives a message from a system that supports an older version of the standard, then the system supporting the current version of the standard sends out Misbehavior Detection Messages if a packet is received that does not adhere to the standard supported by its system. However, since the controller 130 supports both a current version of the standard and an older version of the standard, then the misbehavior detection system would not flag a message received having an old version format as “wrong” as long as they adhere to the old version of the standard and therefore the misbehavior detection also accepts them, meaning no respective message is sent out.

The described controller 130 also works for more supported versions of the standard. If more than two versions are supported, the controller 130 may decide if messages with the current version are sent out, or additional messages with other versions can be sent out as well, based on the bandwidth the controller 130 may decide if messages 116 supporting only the newest version of the V2X standard are being sent all the time or also messages 116 supporting one or more older versions, with the respective impact on consumed bandwidth.

The one or more applications 150 may include, but are not limited to Intersection Movement Assist (IMA), Forward Collision Warning (FCW), and Do Not Pass Warning (DNPW), Left Turn Assist (LTA), Electronic Emergency Brake Light (EEBL), Signal Violation Warning (SVW), Traffic Light Assist (TLA), Green Light Optimized Speed Advisory (GLOSA). Other applications may also be included. The IMA application 150 allows the vehicle 100 to receive messages/signals 114 from other vehicles approaching an intersection from all directions. The IMA application 150 calculates a potential of a collision and provides the driver of the vehicle 100 with an IMA warning message 154 that advises the driver with progressive urgency. Therefore, the IMA allows the vehicle 100 to be aware of another vehicle even though the driver of the first vehicle does not see the second vehicle. The FCW application 150 calculates a potential of an impending rear-end collision with another vehicle ahead of the current vehicle 100 in traffic, in the same lane moving in the same direction. The FCW application 150 provides the driver with an FCW warning message 154 that advises the driver with progressive urgency. The DNPW application 150 provides the driver of the vehicle 100 with a DNPW warning message 154 during a passing maneuver attempt when a slower-moving vehicle ahead of the vehicle 100 cannot be passed safely using a passing zone, due to the passing zone being occupied by vehicles moving in the opposite direction. In some examples, the DNPW application 150 provides the warning message 154 even though the driver is not attempting to pass the vehicle 100 in front of him/her. The LTA application 150 provides the driver with an LTA warning message 154 that warns the driver during a left turn attempt when it is not safe to enter an intersection or continue in the left turn attempt, due to a vehicle approaching the same path without an intent to stop. The EEBL application 150 enables the vehicle to transmit a self-generated emergency brake event to surrounding vehicles. In addition, when receiving an EEBL message from another vehicle, the EEBL application of the current vehicle 100 determines the relevance of the event and, if appropriate, provides an EEBL warning message 154. The SVW application provides the driver with an SVW warning message 154 that informs the driver of potential upcoming signal (i.e., traffic light) violation. The TLA application 150 determines data related to a traffic signal, tailback, and the geometry on an intersection and provides the driver with a TLA warning message 154 relating the traffic signal. The GLOSA application 150 determines the optimal speed for approaching the next traffic light and informs the driver with a warning message 154 of that optimal speed. In some examples, each application sends the warning message 154 to the driver and an output message 116, 116a, 116b relating to the warning message 154 to other entities such as other vehicles, an infrastructure, a network, a pedestrian, a device, and/or a grid.

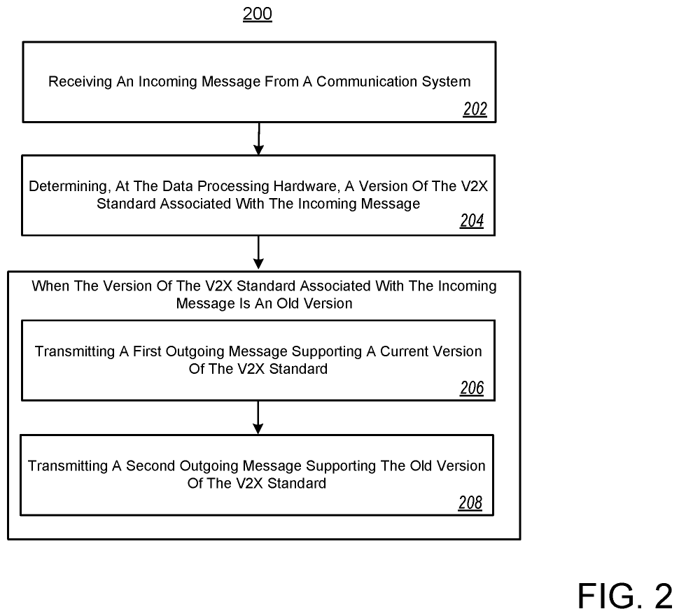

FIG. 2 provides an example arrangement of operations for a method 200 for supporting at least two versions of a vehicle-to-everything (V2X) standard the system FIG. 1. At block 202, the method 200 includes receiving, at data processing hardware 130, 132, an incoming message 114 from a communication system 110. At block 204, the method 200 includes determining, at the data processing hardware 130, 132, a version of the V2X standard associated with the incoming message 114, 114a, 114b. When the version of the V2X standard associated with the incoming message 114, 114a, 114b is an old version, the method 200, at block 206 includes transmitting, from the data processing hardware 130, 132, a first outgoing message 116, 116b supporting a current version of the V2X standard. In addition, when the version of the V2X standard associated with the incoming message 114, 114a, 114b is an old version, the method 200, at block 208, includes transmitting, from the data processing hardware 130, 132, a second outgoing message 116, 116a supporting the old version of the V2X standard.

In some implementations, when the version of the V2X standard associated with the incoming message 114, 114b is the current version, then the method 200 includes transmitting, from the data processing hardware 130, 132, the first outgoing message 116, 116b supporting the current version of the V2X standard.

In some examples, the data processing hardware 130, 132 executes one or more applications 150, 150a-n configured to receive the incoming message 114, 114a, 114b and output the first outgoing message 116, 116b and the second outgoing message 116, 116a. The one or more applications 150, 150a-n may include at least one of: Intersection Movement Assist (IMA), Forward Collision Warning (FCW), and Do Not Pass Warning (DNPW), Left Turn Assist (LTA), Electronic Emergency Brake Light (EEBL), Signal Violation Warning (SVW), Traffic Light Assist (TLA), or Green Light Optimized Speed Advisory (GLOSA). The one or more applications 150, 150a-n may include any other application configured to receive the incoming message 114, 114a, 114b and output the first outgoing message 116, 116b and the second outgoing message 116, 116a.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, model-based design with auto-code generation, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for supporting at least two versions of a vehicle-to-everything (V2X) standard, the method comprising:
receiving, at data processing hardware, an incoming message from a communication system;
determining, at the data processing hardware, a version of the V2X standard associated with the incoming message;
when the version of the V2X standard associated with the incoming message is an old version:
transmitting, from the data processing hardware, a first outgoing message supporting a current version of the V2X standard; and
transmitting, from the data processing hardware, a second outgoing message supporting the old version of the V2X standard.

2. The method of claim 1, further comprising:
when the version of the V2X standard associated with the incoming message is the current version:
transmitting, from the data processing hardware, the first outgoing message supporting the current version of the V2X standard.

3. The method of claim 1, wherein the data processing hardware executes one or more applications configured to receive the incoming message and output the first outgoing message and the second outgoing message.

4. A system for supporting at least two versions of a vehicle-to-everything (V2X) standard, the system comprising:
data processing hardware;
memory hardware in communication with the data processing hardware, the memory hardware storing instructions that when executed on the data processing hardware cause the data processing hardware to perform operations comprising:
receiving an incoming message from a communication system;
determining a version of the V2X standard associated with the incoming message;
when the version of the V2X standard associated with the incoming message is an old version:
transmitting a first outgoing message supporting a current version of the V2X standard; and
transmitting a second outgoing message supporting the old version of the V2X standard.

5. The system of claim 4, wherein the operations further comprise: when the version of the V2X standard associated with the incoming message is the current version:
transmitting the first outgoing message supporting the current version of the V2X standard.

6. The system of claim 4, wherein the data processing hardware executes one or more applications configured to receive the incoming message and output the first outgoing message and the second outgoing message.
